(19) United States
(12) Patent Application Publication
(10) Pub. No.: US 2026/0065732 A1
(43) Pub. Date: Mar. 5, 2026

(54) MULTI-LANE VEHICLE ACCESS USING ULTRA-WIDEBAND SYSTEMS AND METHODS

(71) Applicant: THE CHAMBERLAIN GROUP LLC, OAK BROOK, IL (US)

(72) Inventors: Michael Phillips, Warrenville, IL (US); Casparus Cate, Chicago, IL (US)

(21) Appl. No.: 18/822,648

(22) Filed: Sep. 3, 2024

(51) Int. Cl. G07C 9/15; G07C 9/20

(52) U.S. Cl. CPC G07C 9/15; G07C 9/20

(57) ABSTRACT

An access control system for controlling vehicle flow through a multi-lane access point can be configured to receive first and second ultra-wideband signals and analyze the first and second ultra-wideband signals to determine respective first and second position data associated with the respective first and second vehicles. The system can determine, based on the first position data, a location of the first vehicle within the multi-lane access point. The system can determine, based on the second position data, a location of the second vehicle within the multi-lane access point. The system can transmit, to a first movable barrier operator, an instruction to open a first movable barrier for the first vehicle, based on the determined location of the first vehicle.

### TECHNICAL FIELD

This disclosure relates to access control systems and, more specifically, to access control systems that provide access for movable barrier operator systems.

### BACKGROUND

Access control systems can provide access to a secured space, such as a garage or a residence. This access can be provided via movable barrier operators, which control access to the secured space. Various types of movable barrier operator systems are known such as garage door operators, gate operators, rolling shutter systems, and pet access systems. Examples of movable barriers include garage doors, swinging or sliding gates, shutters, pet doors, etc. Movable barriers are movable between closed and open positions to allow ingress and egress of vehicles, people, pets, etc. to and from various secured areas such as a garage of a home. Some operations of these systems may be automatically enabled or triggered based on a location of a detected device associated with a user of the system. Modern systems lack many of the benefits of systems described herein.

### SUMMARY

Aspects and advantages of the invention in accordance with the present disclosure will be set forth in part in the following description, or may be obvious from the description, or may be learned through practice of the technology.

In some embodiments, an access control system for controlling vehicle flow through a multi-lane access point can be configured to receive first and second ultra-wideband signals and analyze the first and second ultra-wideband signals to determine respective first and second position data associated with the respective first and second vehicles. The system can determine, based on the first position data, a location of the first vehicle within the multi-lane access point. The system can determine, based on the second position data, a location of the second vehicle within the multi-lane access point. The system can transmit, to a first movable barrier operator, an instruction to open a first movable barrier for the first vehicle, based on the determined location of the first vehicle.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

FIG. 1 shows an example movable barrier operator system for operating a garage door, in accordance with some embodiments.

FIG. 2 shows another example access control system, according to some embodiments.

FIG. 3 shows a perspective view of another example access control system, according to some embodiments.

FIG. 4 shows an example method that can be performed a system described herein, according to some embodiments.

FIG. 5 shows another example access control system that is a pet access system, according to some embodiments.

FIG. 6 shows another example method that can be performed a system described herein, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions, operations and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein that utilize data from a sensor of an access control system to control operations of the access control system and control access to a secured area such as a parking structure, garage, residence, and/or other structure or space. The sensor may include, for example, one or more wireless signal sensors. For example, ultra-wideband (UWB) sensors can be used to capture data from vehicles or other objects in or around the secured area or access point. Additionally or alternatively, other sensors such as cameras can be configured to capture image data from a monitored area associated with the secured area. The systems, apparatuses and methods as described herein are utilized in conjunction with an auto-secure operation that can allow the access control system to secure the area (e.g., parking garage, residence) against entry by an individual or vehicle, which may be based on a location and/or authorization of a vehicle or other object. The systems described herein can allow for automation of control of an access control system. Embodiments described herein may be used in parking, distribution centers, gated communities and/or any situation with facilities or communities with multiple access points and many people or vehicles seeking access to a space.

With sensors and systems described herein, UWB systems that are built into vehicles can allow for advanced access control methods. Certain embodiments described herein can allow access control systems to not only detect when a vehicle is nearby but also determine the specific location of the vehicle. For scenarios where there are multiple parallel access points or local areas (e.g., associated with multiple lanes), knowing exactly which access point the vehicle is in front of would be particularly advantageous.

For residential control access points, UWB can be advantageous as well. Other technologies, such as on-off keying (OOK) can detect whether a vehicle is in range of a radio frequency (RF) signal sensor. Such technologies may be insufficient alone to identify a position of the vehicle since the vehicle could be anywhere where the RF signal sensor is in range of the vehicle (e.g., in a backyard). Line of sight systems may also be insufficient on their own since identifying a position of a vehicle may require to “see” past an obstruction, such as another vehicle.

Other technologies are helpful, but they may be insufficient on their own to identify a position of a vehicle or insufficient in another way. For example, Bluetooth Low Energy (BLE) can provide some information regarding positioning of the vehicle with some ability to look at signal strength. However, BLE-even with a combination of OOK-would not be able to provide information about precise location of the vehicle. For example, BLE and OOK would not be able to provide queue position at an access point (e.g., a parking garage terminal). OOK is unidirectional and includes airtime limitations. Even BLE's beacon functionality, including airtags, and/or multi-beacon functionality is an improvement over OOK on determining some positioning information, but it is insufficient to identify precise location (e.g., queue position, lane position) of a target vehicle. By contrast, with UWB in combination with the embodiments described herein, precise positioning can be identified. Modern machines generally rely on a user to feed a ticket into a machine and/or scan a QR code, each of which requires at least two manual processes. These are cumbersome and slow. Even systems that can scan a license plate can be insufficient since many states do not require front number plates on a vehicle. Additionally or alternatively, systems relying only on scanning technologies may be prone to error due to limitations of any line-of-sight system, such as obstructions or imaging malfunctions. Additionally, imaging sensing systems alone would require an imaging system for each lane of a multi-lane access point.

In some embodiments, a Wi-Fi dongle and/or smart device (e.g., smartphone) may be used for providing geofencing information, which can generate ranging information. For example, in a parking garage with a multiple-gate entry, as a vehicle approaches one of the gates, it can connect via Bluetooth to validate access credentials. Once the validation is complete, the system may use the UWB signal to determine a lane the vehicle is in and/or confirm that the vehicle is in fact next in line to enter (e.g., no one else is in front of the vehicle). If a vehicle has a UWB system built in, a UWB/BLE tag may be mounted inside the vehicle (e.g., inside the vehicle window) to allow detection by the systems described herein. Certain embodiments may be used in residentials spaces with multicar garages.

In some embodiments, an accessory (e.g., base station) may be mounted outside the garage to relay the UWB signal in the event that the UWB signal is unable to penetrate the garage door. In some embodiments, a single UWB sensor can monitor multiple lanes for both entry and exit. Additionally or alternatively, in some embodiments a reservation of a parking spot or time entry can automatically add a vehicle to a whitelist for an access point. Such a whitelist can allow the access point to automatically grant access and/or exit rights as the vehicle arrives at the gate.

In some embodiments, the systems may be able to detect UWB technology embedded in the user's smart device. This may provide a proxy location for a vehicle and allow automated access control to a vehicle based on the location of the smart device relative to the access point.

In some embodiments, a combination of license plate recognition (LPR) and imaging sensors (e.g., video cameras) can be used to track an identification and location of a vehicle. Additionally or alternatively, an image sensor may identify and/or read text on a surface (e.g., ground, sign, wall). Such character recognition can be useful in identifying a vehicle and/or a location of a vehicle. In some embodiments, an ephemeral QR code (e.g., using electronic ink (c-ink)) and/or a display may provide location information about the vehicle. For example, light indicators (e.g., red lights, green lights) can illuminate a location of the vehicle within the secure access area. Such illumination may indicate, for example, whether a parking spot is free. Reference to the figures will now be made.

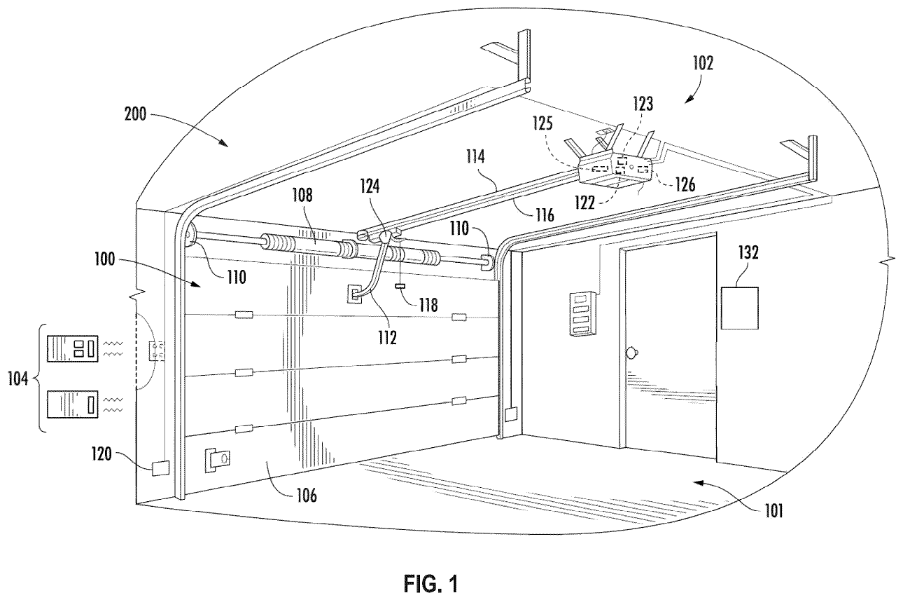

Referring now to FIG. 1, an access control system 200 is provided that includes a movable barrier operator system 100 for operating a movable barrier, such as a garage door 106, that limits access to a secured area, such as a garage 101. In one embodiment, the movable barrier operator system 100 includes a movable barrier operator, such as a garage door operator 102, and one or more remote controls such as a transmitter 104. The one or more remote controls may also include, for example, a user device such as a smartphone, a laptop computer, a tablet computer, a wearable device, an in-vehicle device such as an infotainment system coupled to an in-vehicle transmitter, a keypad external to the garage 101, a wall control, a visor-mounted remote control, and/or a handheld transmitter such as a key fob. The garage door operator 102 includes an electric motor 122, communication circuitry 123, and a control circuit (including a processor 125 and a memory 126). The processor 125 may include, for example, a microprocessor, a system-on-a-chip, an application specific integrated circuit (ASIC), and/or a field programmable gate array (FPGA). The processor 125 can be one processor or a plurality of processors that are operatively connected. The memory 126 may include, for example, an electrical charge-based storage media such as EEPROM or RAM, or other non-transitory computer readable media such as an optical or magnetic-based storage device. The memory 126 can store information that can be accessed by the processor 125. For instance, the memory 126 (e.g., one or more non-transitory computer-readable storage mediums, memory devices) can include computer-readable instructions that can be executed by the processor 125. The instructions can be software, firmware, or both written in any suitable programming language or can be implemented in firmware or hardware. Additionally, or alternatively, the instructions can be executed in logically and/or virtually separate threads on processor 125. For example, the memory 126 can store instructions that when executed by the processor 125 cause the processor 125 to perform operations such as any of the operations and functions as described herein.

In some embodiments, the garage door operator 102 includes a rail 116 and drive member 114 such as a chain, belt, or screw driven by the motor 122 relative to the rail 116. The electric motor 122 in cooperation with the drive member 114 is operable to move the garage door 106 between open and closed positions. For example, a trolley 124 is coupled to the drive member 114 as well as an arm 112 that is attached to the garage door 106. The motor 122 shifts the trolley 124 back-and-forth along the rail 116 to lift and lower the garage door 106. A release mechanism 118 is coupled to the trolley 124 to allow the garage door 106 to be disconnected from the garage door operator 102 for manual operation such as during a power failure.

The movable barrier operator system 100 includes a drum and cable mechanism 110 that is attached to the garage door 106. The drum and cable mechanism 110 includes a drum and a corresponding cable on each side of the garage door 106. The cable is paid out from and wound up onto the drum when the garage door 106 is respectively lowered and raised. The drum and cable mechanism 110 couples to a counterbalance such as a torsion spring 108 that assists in lifting the weight of the garage door 106 and enables the garage door operator 102 to open or close the garage door 106 via movement of the trolley 124. In some embodiments, an optical device such as a photo eye system 120 senses an obstruction (e.g. object and/or a human) that may be in the path of the garage door 106 as the garage door 106 closes.

With continued reference to FIG. 1, the access control system 200 may include a communication bridge or hub 132 in the secured area. The communication hub 132 may facilitate communication between the garage door operator 102, photo eye system 120, transmitter 104, and/or a remote resource such as a server computer. The communication hub 132 may facilitate opening and closing of the garage door 106 based on various detected conditions. For example, the communication hub 132 may be configured to receive and/or decode ultra-wideband signals emitted from an object, such as a vehicle, smart device, or other object. The access control system 200 may include other components not shown in FIG. 1, such as cameras proximate to the front, rear, side, etc. doors or at other exterior and/or interior locations of the residence.

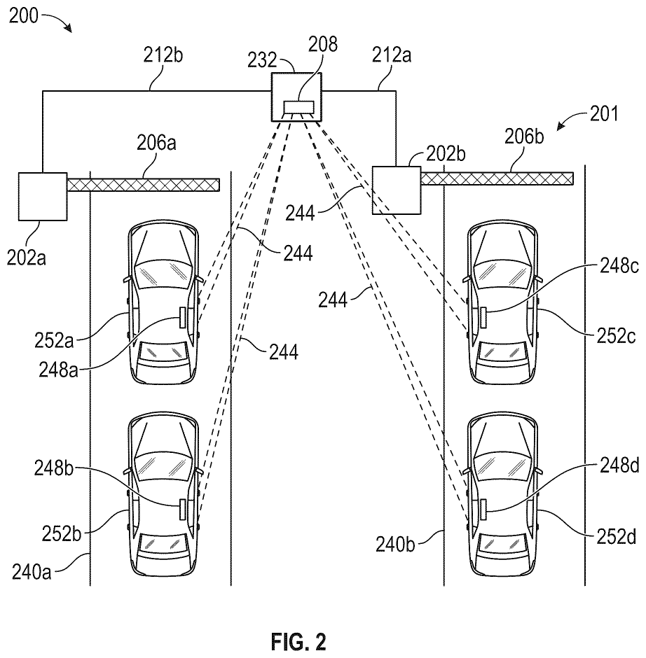

FIG. 2 shows another example access control system 200, according to some embodiments. The access control system 200 shown in FIG. 2 may include one or more elements from the access control system 200 shown in FIG. 1. The access control system 200 may include one or more movable barrier operators 202a, 202b; respective one or more movable barriers 206a, 206b; and a communication hub 232.

The communication hub 232 may include one or more features of the communication hub 132 described above. The communication hub 232 may include one or more processors and/or memory (not shown). The one or more processors may include one or more features of the processor 125 described above. The memory may include one or more features of the memory 126 described above.

The communication hub 232 can include a data interface 208 that is configured to receive and/or transmit ultra-wideband signals. The data interface 208 may be an ultra-wideband data interface. The data interface 208 may include an ultra-wideband (UWB) sensor. In some embodiments, the data interface 208 is configured to capture and/or transmit non-ultra-wideband signals (e.g., infrared, Bluetooth (e.g., BLE), on-off keying, radio frequency, etc.). The data interface 208 may not require line of sight to capture the information about the objects (e.g., vehicles 252a, 252b, 252c, 252d). This can be a particular advantage of the systems described herein over traditional systems.

The UWB sensor can provide precise location information. Accordingly, the communication hub 232 may be able to accurately measure the time it takes for signals to travel between the UWB sensor and one or more objects, such as the vehicles 252a, 252b, 252c, 252d. This may represent a time-of-flight measurement. Using data from the time-of-flight measurement, the communication hub 232 can calculate a distance to the vehicles 252a, 252b, 252c, 252d. In some embodiments, the communication hub 232 can obtain information related to an angle associated with each of the vehicles 252a, 252b, 252c, 252d relative to the communication hub 232. Using the time-of-flight data and/or the angle information, the communication hub 232 can calculate positioning data. In some embodiments, the access control system 200 includes a plurality of communication hubs 232, each having one or more ultra-wideband (UWB) sensors, networked together to cover a larger area.

In some embodiments, the communication hub 232 is configured to track movement of the vehicles 252a, 252b, 252c, 252d within or near the access point 201. The UWB sensor can provide continuous data on the distance and position of the vehicles 252a, 252b, 252c, 252d to track the movement of vehicles within the parking structure. For example, the UWB sensor can calculate the positioning data at least once every 10 second, such as at least one every second, such as at least one every 0.25 seconds, such as at least once every 0.1 second, such as at least once every 0.01 seconds, etc. Movement tracking may be useful for monitoring traffic flow, tracking available parking spaces, and/or managing parking resources. In some embodiments, a UWB sensor can be configured to send signals to one or more vehicles to guide the vehicle(s) through the access point (e.g., garage) or to the access point (e.g., of a garage).

In some embodiments, the communication hub 232 can transmit a confirmation signal to one or more of the vehicles 252a, 252b, 252c, 252d. Such confirmation signals may be transmitted via a direct link to the vehicle (e.g., through the head unit, such as via a vehicle signal transceiver 248a, 248b, 248c, 248d), via a smart device, and/or through a server/portal remote from the communication hub 232.

The data interface 208 may be configured to receive/transmit signals within one or more frequency ranges. In some embodiments, the data interface 208 can receive/transmit signals between about 3.1 GHz to 10.6 GHz. Additionally or alternatively, the data interface 208 can transmit/receive short pulses of energy. In some embodiments, the data interface 208 can transmit data at high speeds to allow for real-time position and/or movement tracking.

Use of ultra-wideband signals can be beneficial since they are generally less susceptible to multi-path interference compared to narrowband signals. Thus, the accuracy of distance and/or movement measurements can be reliable in signal-complex environments like parking structures with reflective surfaces.

The vehicles 252a, 252b, 252c, 252d may be equipped with respective vehicle signal transceivers 248a, 248b, 248c, 248d. Each of the vehicle signal transceivers 248a, 248b, 248c, 248d may be configured to transmit/receive vehicle signals 244 to/from the communication hub 232. The vehicle signal transceivers 248a, 248b, 248c, 248d may be associated with the vehicles 252a, 252b, 252c, 252d themselves. For example, newly manufactured vehicles are frequently manufactured with UWB-compatible components, such as tags which are detectable by a UWB sensor and/or other sensing equipment. The UWB-compatible components may be disposed around the vehicle at known locations, such as within fenders, wheel wells, or other cavities of the vehicle body. The UWB-compatible components can form a unique fingerprint associated with each vehicle type and detectable by a UWB sensor. For example, the data interface 208 may include a lookup table or be in communication with a remote memory storing the lookup table. The lookup table can include information associated with the fingerprint of different vehicle types. The data interface 208 can compare the detected fingerprint to the lookup table to determine the vehicle type.

The vehicle signal transceivers 248a, 248b, 248c, 248d may also or alternatively be associated with a user device (e.g., smart device) of a user within the respective vehicles 252a, 252b, 252c, 252d. One or more of the vehicle signal transceivers 248a, 248b, 248c, 248d may include non-ultra-wideband signal transceivers. In some embodiments, the vehicle signal transceivers 248a, 248b, 248c, 248d can include a dongle and/or smart device (e.g., smartphone) that allows for ultra-wideband signal reception and/or transceiving. The vehicle signal transceivers 248a, 248b, 248c, 248d may be configured to indicate to the communication hub 232 dimensional information about the vehicles 252a, 252b, 252c, 252d. For example, each of the vehicle signal transceivers 248a, 248b, 248c, 248d may include a unique ultra-wideband signature that allows the communication hub 232 to understand how long the corresponding vehicle 252a, 252b, 252c, 252d is for purpose of communicating to the corresponding movable barrier 206a, 206b when to modify a condition of the movable barriers 206a, 206b (e.g., when to close, when to open). For example, it may be helpful to close the appropriate movable barrier 206a, 206b without a secondary vehicle also passing through the barrier without authorization.

Based on these vehicle signals 244, the communication hub 232 may be able to identify which lane 240a, 240b of the access point 201 and position (e.g., first, second, third, etc.) within that lane 240a, 240b that each vehicle 252a, 252b, 252c, 252d is in. For example, as shown, the first vehicle 252a is in the first position within the first lane 240a. The second vehicle 252b is in the second position within the first lane 240a. The third vehicle 252c is within the first position of the second lane 240b. The fourth vehicle 252d is in the second position of the second lane 240b. Thus, the second vehicle 252b is behind the first vehicle 252a (and behind the third vehicle 252c), and the fourth vehicle 252d is behind the third vehicle 252c (and behind the first vehicle 252a). In some embodiments, vehicles in the first lane 240a are configured to communicate with the communication hub 232 via ultra-wideband while vehicles in the second lane 240b are configured to communicate with the communication hub 232 using non-ultra-wideband signals (e.g., infrared, BLE, OOK, etc.). In an embodiment, the second lane 240b can be further configured to communicate with the communication hub 232 using ultra-wideband signals. The first lane 240a may include indicia, such as signage, indicating UWB compatibility to allow UWB-capable vehicles to queue in/at the first lane 240a.

The communication hub 232 may be configured to automatically identify the lane and position of each of the vehicles 252a, 252b, 252c, 252d, automatically handle a transaction (e.g., payment) with one of the vehicles 252a, 252b, 252c, 252d, and/or automatically open and/or close a corresponding movable barrier 206a, 206b. The communication hub 232 may be able to identify when a vehicle (e.g., the first vehicle 252a, the third vehicle 252c) has passed the corresponding movable barrier 206a, 206b. The transaction may include deducting a payment from an account associated with the corresponding vehicle(s). This may include having the communication hub 232 communicate wirelessly or via a wire to a remote computing device, such as a server or cloud system.

For example, the communication hub 232 may identify that the third vehicle 252c is in the first position in front of the second movable barrier 206b and is therefore ready to transact and/or exit the access point 201 via the second movable barrier 206b. Accordingly, the communication hub 232 may send a signal to the second movable barrier operator 202b to open the second movable barrier 206b to allow the third vehicle 252c to exit. Additionally or alternatively, the communication hub 232 may track a position and/or movement of the fourth vehicle 252d (and/or of the third vehicle 252c) to close the second movable barrier 206b after the third vehicle 252c has exited the access point 201 but before the fourth vehicle 252d exits the access point 201. The communication hub 232 may transmit instructions to the movable barriers 206a, 206b via respective one or more data links 212a, 212b. The data links 212a, 212b may be wired and/or wireless. The communication hub 232 may be integrated into the access point (e.g., parking structure), such as by being embedded in the concrete. Additionally or alternatively, the communication hub 232 may be a standalone unit. The communication hub 232 may be mounted at or near the ceiling of the access point (e.g., parking structure). Alternatively, or in addition, the communication hub 232 (or a secondary communication hub 232) can be mounted at or near a surface level of the access point (e.g., parking structure).

In some embodiments, the access control system 200 may be configured to track a time of entry of a corresponding vehicle 252a, 252b, 252c, 252d. This may be accomplished using the same vehicle signal transceivers 248a, 248b, 248c, 248d communicating with (e.g., to) the communication hub 232. Additionally or alternatively, another system, such as BLE, OOK, RF signaling, may work together with the ultra-wideband system. In some embodiments, the data interface 208 can receive each of these signals and transmit the received signal(s) to the processor(s).

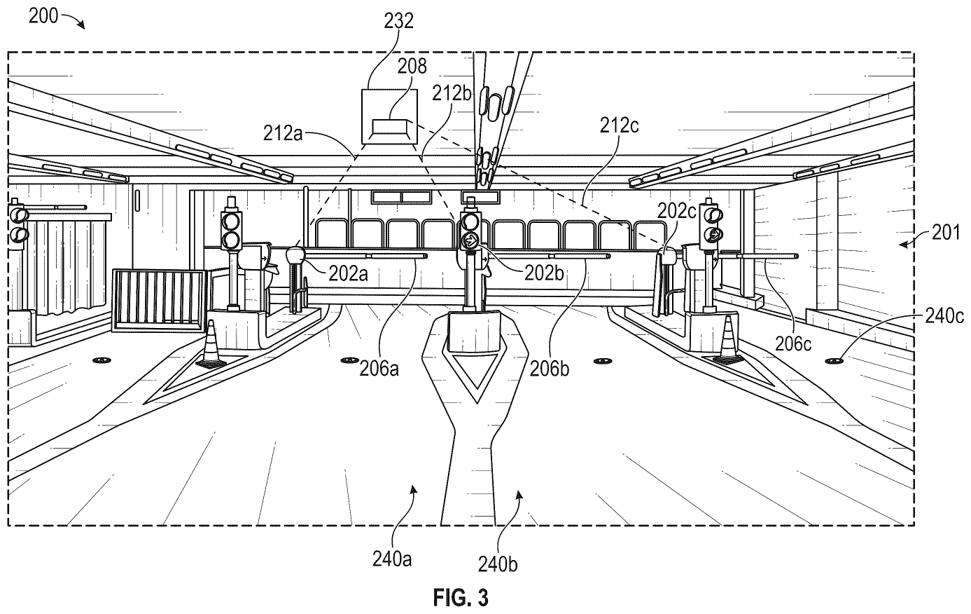

FIG. 3 shows a view of another example access control system 200 as seen approaching the access control system 200, according to some embodiments. The access control system 200 shows a plurality of lanes 240a, 240b, 240c with corresponding movable barriers 206a, 206b, 206c and movable barrier operators 202a, 202b, 202c. The access control system 200 can include a communication hub 232 that includes a data interface 208. The data interface 208 can be a wired or wireless data interface. As shown, the data interface 208 is a wireless data interface configured to communicate wirelessly with each of the movable barrier operators 202a, 202b, 202c. The data interface 208 can cause one or more of the movable barrier operators 202a, 202b, 202c to open or close based on communication received from one or more vehicles in a corresponding lane 240a, 240b, 240c.

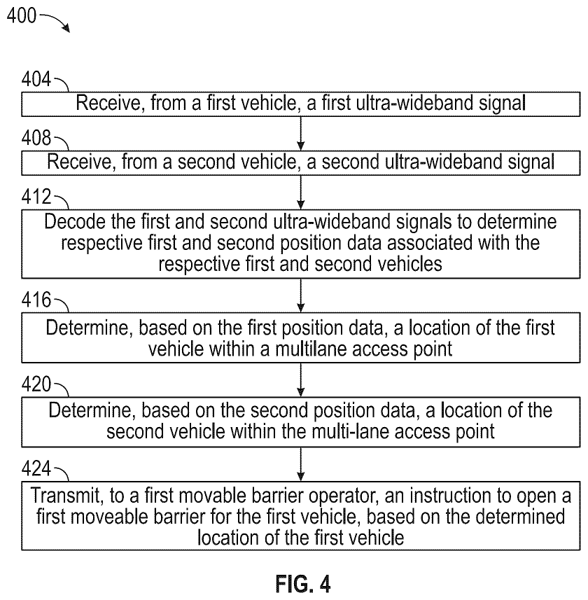

FIG. 4 shows an example method 400 that can be performed by a system described herein (e.g., the movable barrier operator system 100, the access control system 200, the communication hub 232, etc.). The method 400 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At block 404, the system can receive (e.g., from a first object such as a first vehicle) a first ultra-wideband signal. At block 408, the system can receive (e.g., from a second object such as a second vehicle) a second ultra-wideband signal. At block 412, the system can process (e.g., decode) the first and second ultra-wideband signals to determine respective first and second position data associated with the respective objects (e.g., the first and second vehicles). In some embodiments, this decoding of the first and/or second ultra-wideband signal(s) can include preventing decoding of identity information associated with the first and/or second object(s).

At block 416, the system can determine (e.g., based on the first position data) a location of the first object within the access point and, at block 420, determine (e.g., based on the second position data) a location of the second vehicle within the access point. At block 424, the system can transmit an instruction to open a first movable barrier for the first object. The transmission may be to the first movable barrier operator and/or based on the determined location of the first vehicle.

In some embodiments, the method 400 can include determining that the first and second objects (e.g., vehicles) are in a common area, such as a common lane. For example, the system may identify a relative position within the area of the access point of the first vehicle in a queue or group of objects in the area. The position or location of the first and/or second objects may include a relative point or relative location of the first and/or second objects to the UWB sensor or other sensor (e.g., RF signal sensor, imaging sensor). The relative location may include a coordinate point or GPS location associated with the first object relative to the access point and/or relative to a second or other object in the access point. Additionally or alternatively, the method 400 can include determining that the second object is in a particular location (e.g., behind, in front of, next to, etc.) relative to the first vehicle in the common area of the access point. The system may determine that the first object has passed a certain threshold location within the access point (e.g., past the first moveable barrier). The system can transmit an instruction to close the first moveable barrier based on a determination that the first object has passed the certain threshold location (e.g., past the first moveable barrier).

In some embodiments, the system can receive, from the second object, an updated second ultra-wideband signal and determine, based on the updated second ultra-wideband signal, an updated location of the second object with respect to the access point. In some embodiments, the system can transmit (e.g., to the first movable barrier operator) an instruction to open the first moveable barrier for the second vehicle, based on the determined updated location of the second object. In some embodiments, the system can determine that the first object is in a first area (e.g., lane) and determine that the second object is in a second area of the access point. Additionally or alternatively, the system may transmit (e.g., to a second movable barrier operator) an instruction to open a second moveable barrier for the second object, based on the determination that the second object is in the second area.

The method 400 may include transmitting, to the first object, a confirmation signal indicating reception of the first ultra-wideband signal. The confirmation signal may be communicated, for example, to the vehicle (such as a head unit), a user device associated with the vehicle (such as a user device like a smart phone), a dongle or other accessory integrated with the vehicle, or the like. Additionally or alternatively, the system may receive (e.g., from the first object) in response to transmitting the instruction to open the first moveable barrier for the first vehicle, an indication of successful transaction (e.g., payment).

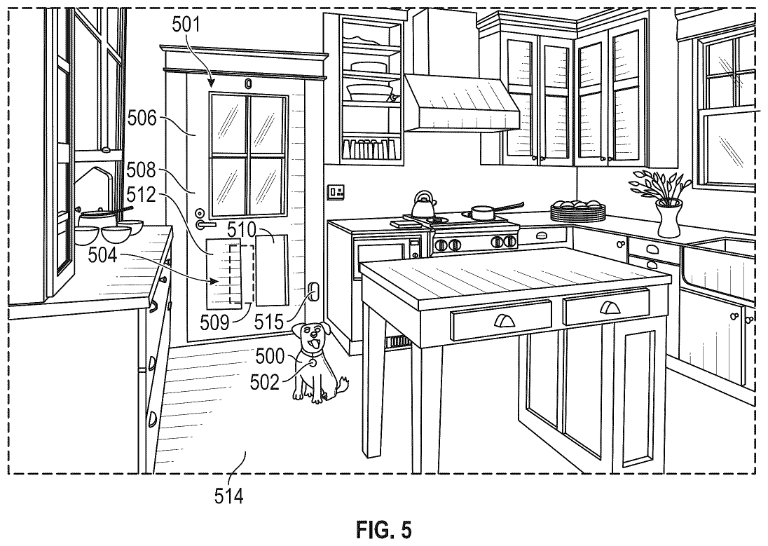

FIG. 5 shows another example access control system that is a pet access system 501, according to some embodiments. FIG. 5 shows how access control systems described herein can apply to various other embodiments and scenarios. For example, in FIG. 5, a pet door 509 is in an open position and at least partially within an internal compartment, such as a void or a pocket of, the door 506. The pocket may be defined by a body 508 of the door 506 between substantially parallel, planar internal and external walls of the body 508. With the pet door 509 in the open position, an opening 510 is formed in door 506 sized to permit the pet 500 to travel through the opening 510 into or out of the secured area 514. The pet door 509 closes the opening 510 when the pet door 509 is in a closed position. The pet door 509 may look visually similar to the rest of the door 506. For example, the pet door 509 may look like another panel of the door, such as panel 512, to conceal the pet door 509 when the pet door 509 is closed. Further, the pet access system 501 may include an ultra-wideband device 515 (e.g., a communication hub) that can detect proximity of the pet-carried ultra-wideband device 502 and trigger operation of the pet door 509 in response to such detection. The pet access system 501 may have a processor operably coupled to the ultra-wideband device 515 that measures angle of arrival of ultra-wideband signals from the ultra-wideband device 502 to detect whether the ultra-wideband device 502 (and the pet associated therewith) has passed through the opening 510 or not and, if so, what direction the ultra-wideband device 502 is moving.

During setup of the pet access system 501, the user may hold the ultra-wideband device 502 in the user's hand and move gradually toward the pet door 509 until the pet access system 501 detects the ultra-wideband device 502 and opens the pet door 509. The user records the distance, such as by entering the distance into a user device paired with the pet access system 501, and repeats the process with different approach angles to the door to confirm that the ultra-wideband device 502 will open the pet door 509 regardless of the approach angle. Further still, in embodiments where the door 506 is a door into the garage 101, the pet access system 501 may work in conjunction with the movable barrier operator system 100 to additionally operate the movable barrier operator (e.g., garage door operator 102) to open the movable barrier (e.g., garage door 106) to enable the pet 500 to exit the garage 101. Further, the user may manually move the ultra-wideband device 502 through the pet door 509 during setup of the pet access system 501 to confirm that the pet access system 501 detects a correct direction of movement of the ultra-wideband device 502 through the pet door 509.

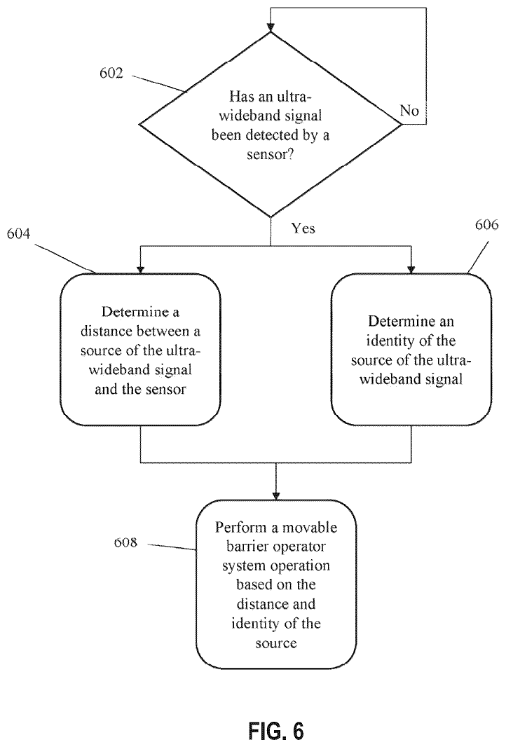

Turning now to FIG. 6, operation of the movable barrier operator system will be described in more detail. A method 600 is provided for operating the movable barrier operator system and may include determining 602 whether an ultra-wideband signal has been detected e.g., by an ultra-wideband device such as an ultra-wideband anchor or a device. In some embodiments, the detected ultra-wideband signal(s) detected at step 602 may be reflected from passive device(s) based on an initial ultra-wideband signal broadcast by the communication hub. In some embodiments, the processor may be configured to perform the determination 602 and the relevant devices being monitored/detected may include the vehicle signal transceivers 248a, 248b, 248c, 248d and/or the communication hub 232. When no ultra-wideband signals have been detected, the method 600 can include continuing to monitor for those signals.

However, when an ultra-wideband signal has been detected at operation 602, the method 600 may include determining 604 a distance between the detected device and the detecting device or from a specific location such as the movable barrier operator (e.g., garage door operator 102). The distance between the detected device and the detecting device may be determined, for example, by calculating a time of flight of the signal. Additionally or alternatively, the ultra-wideband signal may include angle information of the detected device from the detecting device. In some embodiments, the system can detect a wireless connection (e.g., via BLE or other Bluetooth connection) between the detecting device and the detected device. The method 600 may further include determining 606 an identity of the detected device, which may be based at least in part on the wireless connection. In some embodiments, the processor can determine 604, 606 the distance and identity of the detected devices, e.g., 232, 248a, 248b, 248c, 248d, 502, by analyzing data embedded, in and/or the transmission characteristics of, the ultra-wideband signals received by the ultra-wideband devices. The processor can determine 604, 606 the distance and identity in parallel or serially. The identity and distance may be determined by the processor one after the other in either order. When determining the identity, the processor can retrieve a unique identifier from the ultra-wideband signals and/or other accompanying RF signals such as Bluetooth signals and then match the retrieved unique identifier to a list of unique identifiers stored in the memory 126 that are associated with one or more of, or each of, the ultra-wideband devices 232, 248a, 248b, 248c, 248d, 502. Further, in some embodiments, the processor can identify and/or verify the ultra-wideband device whose ultra-wideband signals are received using other credentials such as a signature of ultra-wideband signal. The processor can employ a time-of-flight and angle-of-approach determination on the received ultra-wide band signals to precisely determine the distance information. In some embodiments, the ultra-wideband devices 232, 248a, 248b, 248c, 248d, 502 may include multiple antennas to enable precise determination of an angle of approach of other of the ultra-wideband devices 232, 248a, 248b, 248c, 248d, 502 from a comparison of the signals as received by each of the antennas. The time-of-flight determination can be made using: single sided two way ranging, double sided two way ranging, and/or time difference of arrival techniques. Further, the angle-of-approach determination can be accomplished using a phase difference of arrival method whereby a phase difference between the received ultra-wideband signal at two or more antennas of the ultra-wideband devices is used to determine the angle of approach.

After the direction and identity are determined, the method 600 can include performing 608 a movable barrier operator system operation based on the distance and identity of the source. In some embodiments, the system operation may be performed after the processor has identified and/or verified that the ultra-wideband signal has been received from a known source such as one of the ultra-wideband devices 232, 248a, 248b, 248c, 248d, 502. The system operation may be selected based on a combination of the identity of the ultra-wideband device and the distance and may include one or more different operations such as a state change operation and/or a proximity-based operation of the movable barrier operator system 100. Each of these different operations are discussed in more detail below.

### State Change Operation

The state change system operation for the movable barrier can be performed with respect to one or more of the objects discussed herein, such as the vehicles 252a, 252b, 252c, 252d or the pet 500. For example, the processor may be configured to cause the movable barrier operator (e.g., the garage door operator, the movable barrier operators 202a, 202b) to open the movable barrier (e.g., the garage door, the movable barriers 206a, 206b, the pet door 509) when one or more of the ultra-wideband devices 232, 248a, 248b, 248c, 248d, 502 enter a predetermined range of other of the ultra-wideband devices. Further, the processor may be configured to cause movable barrier operator to close the movable barrier when the one or more of the ultra-wideband devices 232, 248a, 248b, 248c, 248d, 502 is farther than the predetermined range from the other ultra-wideband devices. As an example in this regard, the processor may cause the movable barrier operator to open the movable barrier when the in-vehicle device (e.g., the vehicle signal transceivers 248a, 248b, 248c, 248d) is detected within range and to close the movable barrier when the in-vehicle device subsequently moves outside of the range.

Further, in some embodiments, the processor can select one of closing the movable barrier, opening the movable barrier, or no action based on the current state of the movable barrier and a location and a moving direction of the ultra-wideband devices 232, 248a, 248b, 248c, 248d, 502 that is detected. For example, where the detected one of the ultra-wideband devices 232, 248a, 248b, 248c, 248d, 502 is inside the garage and moving towards the movable barrier, the processor can select opening the movable barrier as the state change operation when the current state of the movable barrier is closed and select no action when the current state of the movable barrier is open. In some embodiments, this functionality may be suppressed for the ultra-wideband device inside the vehicle because of the speed at which the vehicle travels. Instead, the vehicle may display a warning that the movable barrier is not open. Additionally, where the detected one of the ultra-wideband devices 232, 248a, 248b, 248c, 248d, 502 is inside the garage and moving away from the movable barrier, such as moving into the associated home (e.g. for the ultra-wideband devices 203, 303, and 502) or down the driveway, the processor can select closing the movable barrier as the state change operation when the current state of the movable barrier is open and select no action when the current state of the movable barrier is closed. Further, where the detected one of the ultra-wideband devices 232, 248a, 248b, 248c, 248d, 502 is outside the garage and moving toward the movable barrier, the processor can select opening the movable barrier as the state change operation when the current state of the movable barrier is closed and select no action when the current state of the movable barrier is open. Finally, where the detected one of the ultra-wideband devices 232, 248a, 248b, 248c, 248d, 502 is outside the garage and moving away from the movable barrier, the processor can select closing the movable barrier as the state change operation when the current state of the movable barrier is open and select no action when the current state of the movable barrier is closed.

In some embodiments, the preconfigured range for which the processor triggers the state change operation can be different for each of the ultra-wideband devices 232, 248a, 248b, 248c, 248d, 502. For example, the preconfigured range associated with the in-vehicle ultra-wideband device of vehicle may be greater than the preconfigured range to account for the faster operating speed of the moving object (e.g., vehicle) as compared to the moving speed for users of user devices (e.g., a user interface, a smart device, the vehicle signal transceivers 248a, 248b, 248c, 248d, device 502).

In some embodiments, the processor may direct the movable barrier operator to partially open the movable barrier to a preprogramed height sufficient to allow ingress and/or egress of the object (e.g., vehicle) from the access point. In these embodiments, when the door or barrier is an access point to the garage, the processor can enable the object to move, for example, between the secured area, the garage, and/or the area outside of the garage.

### Proximity-Based Operation

The proximity-based operation of the movable barrier operator system can include operations of the movable barrier operator that are otherwise typically restricted to confirmed line-of-sight or proximity to the movable barrier operator. In some embodiments, these features can include door position limit learning, force learning, and/or transmitter learning of the movable barrier operator. Thus, the movable barrier operator system limits access to these features via remote interfaces on the user devices (e.g., a user interface, a smart device, the vehicle signal transceivers 248a, 248b, 248c, 248d) to situations where the processor has determined that the user devices are within the area that is proximate to the movable barrier operator. As one example, the movable barrier operator may communicate a credential, such as a code or a token, to the user device via a Bluetooth radio of the ultra-wideband device, the user provides a user input regarding changing a limit position of the movable barrier to an application running on the user device, and the user device communicates a command based upon the user input and containing the code to the movable barrier operator via the ultra-wideband device. The movable barrier operator changes the limit position of the movable barrier because the command is close enough to the movable barrier operator to receive the ultra-wideband signal.

Various embodiments for limiting access to the proximity-based feature are described herein. For example, in some embodiments, the processor(s) of the user device(s) can be configured to receive an enabling communication from the processor when the ultra-wideband devices are determined to be within the area that is proximate to the movable barrier operator. In response to the enabling communication, the processors can enable previously disabled limit learn, force learn, or similar features via the user interface (such as displayed on a touchscreen of the user interface). For example, when the user device is located outside the area and the user device is located inside the area as seen in FIG. 2, the processor will enable the limit learn, force learn, or similar features within the user interface while the processor refrains from doing likewise. In some embodiments, disabling the features on the user interfaces can include greying out or not presenting options related to those features.

In some embodiments, the distance may be a preset distance programmed into the movable barrier operator. Additionally or alternatively, the distance may be modifiable using an application running on, for example, the user devices. In some embodiments, the application can enable the user to select from different preset values for the distance and/or to input a fully customized value via the user devices. Customization of the distance can be helpful to accommodate varying possible heights of the movable barrier operator within the garage.

Additionally or alternatively, the limit learn, force learn, or similar features can remain enabled within the user interfaces and the processor can be configured to only execute the limit learn, force learn, or other processes when the user device that sent a command to execute the process is within the area. For example, when the user device is located outside the area and the user device is located inside the area, the processor will perform the limit learn, force learn, or similar processes when instructed to do so by the user device and will ignore any similar instructions received from the user device. In some embodiments, the processor can send an error command to the user device whenever the limit learn, force learn, or other processes are not executed because of a lack of proximity to the movable barrier operator.

Further, in some embodiments, the processor can refrain from executing the limit learn, force learn, or other processes so long as any ultra-wideband signals are detected outside the area and/or within a predetermined distance of the movable barrier. For example, when a detected user device is located outside the area and a detecting user device is located inside the area, the processor may refrain from executing the limit learn, force learn, or similar processes even though the detecting user device is present within the area. In some embodiments, the processor can also refrain from transmitting the enabling communication to the user device so long as the detecting user device is also located outside the area. Further still, in some embodiments, the processor can terminate an action in the event that the user device that sent a command to execute the process leaves the area and/or when any other ultra-wideband signal broadcaster is detected outside the area or within a predetermined distance of the movable barrier.

In some embodiments, the proximity verification using ultra-wideband signals can be supplemented and/or verified by additional processes. For example, the processor can (1) determine whether the user device is connected to a local Wi-Fi network or access point, (2) determine whether the user device is Bluetooth paired with the movable barrier operator, (3) prompt the user device to ask the user to scan a barcode on the movable barrier operator; and/or (4) employ a camera-based technique such as using a camera of the movable barrier operator or a stand-alone camera to perform person/identity recognition on the user in or near the access point.

As an example, the user device may be used to install and setup the movable barrier operator if the user device is within the area. More specifically, installation of the movable barrier operator may include the user opening the box containing the movable barrier operator, connecting the movable barrier operator to a power source, and pairing the user device to the movable barrier operator via an application running on the user device and one or more ultra-wideband signals communicated between the user device and the movable barrier operator. The application may provide step-by-step instructions for installing the movable barrier operator to guide the user through the process.

Once the movable barrier operator is installed, the user may set up the movable barrier operator to enable various operations that utilize ultra-wideband signals using an iterative process. The user may first position a detected user device near the movable barrier operator and provide a user input to the detected user device such as a change to a force limit setting. Next, the user moves the detected user device farther away at set distance intervals, which increases a confidence level of the system that the detected user device has line of sight to the movable barrier operator. To adjust the force limit setting, the processor can associate an updated distance at each interval, calculated from time of flight of the received ultra-wideband signals from the user device and the distance intervals. In this manner, the user may validate the user device is able to control the operability of the movable barrier operator associated with ultra-wideband signals at varying distances from the movable barrier operator.

As another example, the user device may be within the range of the movable barrier operator but outside of the area, such as if the user associated with the user device is sitting in a chair near the movable barrier in an area that leads to the garage. The processor may operate a timer and be programmed to automatically close the movable barrier after the movable barrier has been open for more than a predetermined period of time, such as ten minutes. The processor may be programmed to override the automatic closing of the movable barrier as long as the user device remains within the range of the movable barrier operator such that the movable barrier remains open while the user sits in the chair near the movable barrier.

Further aspects of the invention are provided by one or more of the following example embodiments:

In a 1st Example, an access control system for controlling vehicle flow through a multi-lane access point, the system comprising: an ultra-wideband data interface configured to receive ultra-wideband signals; a non-transitory computer-readable storage storing machine-executable instructions; and a hardware processor in communication with the computer-readable storage, wherein the instructions, when executed by the hardware processor, are configured to cause the system to: receive, from a first vehicle, a first ultra-wideband signal; receive, from a second vehicle, a second ultra-wideband signal; analyze the first and second ultra-wideband signals to determine respective first and second position data associated with the respective first and second vehicles; determine, based on the first position data, a location of the first vehicle within the multi-lane access point; determine, based on the second position data, a location of the second vehicle within the multi-lane access point; and transmit, to a first movable barrier operator, an instruction to open a first movable barrier for the first vehicle, based on the determined location of the first vehicle.

In a 2nd Example, the system of example 1, wherein the instructions, when executed by the hardware processor, are configured to cause the system to: determine that the first and second vehicles are in a common lane.

In a 3rd Example, the system of example 2, wherein the instructions, when executed by the hardware processor, are configured to cause the system to: determine that the second vehicle is behind the first vehicle in the common lane of the multi-lane access point.

In a 4th example, the system of example 3, wherein the instructions, when executed by the hardware processor, are configured to cause the system to: determine that the first vehicle has passed the first movable barrier.

In a 5th example, the system of example 4, wherein the instructions, when executed by the hardware processor, are configured to cause the system to: transmit, based on the determination that the first vehicle has passed the first movable barrier, an instruction to close the first movable barrier.

In a 6th example, the system of example 5, wherein the instructions, when executed by the hardware processor, are configured to cause the system to: receive, from the second vehicle, an updated second ultra-wideband signal; and determine, based on the updated second ultra-wideband signal, an updated location of the second vehicle within the multi-lane access point.

In a 7th example, the system of example 6, wherein the instructions, when executed by the hardware processor, are configured to cause the system to: transmit, to the first movable barrier operator, an instruction to open the first movable barrier for the second vehicle, based on the determined updated location of the second vehicle.

In a 8th example, the system of any of examples 1-7, wherein the instructions, when executed by the hardware processor, are configured to cause the system to: determine that the first vehicle is in a first lane of the multi-lane access point; and determine that the second vehicle is in a second lane of the multi-lane access point.

In a 9th example, the system of example 8, wherein the instructions, when executed by the hardware processor, are configured to cause the system to: transmit, to a second movable barrier operator, an instruction to open a second movable barrier for the second vehicle, based on the determination that the second vehicle is in the second lane.

In a 10th example, the system of any of examples 1-9, wherein the instructions, when executed by the hardware processor, are configured to cause the system to: transmit, to the first vehicle, a confirmation signal indicating reception of the first ultra-wideband signal.

In a 11th example, the system of any of examples 1-10, wherein the instructions, when executed by the hardware processor, are configured to cause the system to: receive, from the first vehicle in response to transmitting the instruction to open the first movable barrier for the first vehicle, an indication of successful payment.

In a 12th example, the system of any of examples 1-11, wherein the location of the first vehicle within the multi-lane access point comprises a relative position within a lane of the multi-lane access point of the first vehicle in a queue of vehicles in the lane.

In a 13th example, the system of any of examples 1-12, wherein the location of the first vehicle within the multi-lane access point comprises a coordinate point associated with the first vehicle relative to the multi-lane access point.

In a 14th example, the system of any of examples 1-13, wherein analyzing the first ultra-wideband signal comprises preventing analyzing of identity information associated with the first vehicle.

In a 15th example, a non-transitory computer-readable medium storing instructions which, when executed by a hardware processor, are configured to: receive, from a first vehicle, a first ultra-wideband signal; receive, from a second vehicle, a second ultra-wideband signal; analyze the first and second ultra-wideband signals to determine respective first and second position data associated with the respective first and second vehicles; determine, based on the first position data, a location of the first vehicle within a multi-lane access point; determine, based on the second position data, a location of the second vehicle within the multi-lane access point; and transmit, to a first movable barrier operator, an instruction to open a first movable barrier for the first vehicle, based on the determined location of the first vehicle.

In a 16th example, the computer-readable medium of example 15, wherein the instructions, when executed by the hardware processor, are configured to: determine that the first vehicle is in a first lane of the multi-lane access point; and determine that the second vehicle is in a second lane of the multi-lane access point.

In a 17th example, the computer-readable medium of example 16, wherein the instructions, when executed by the hardware processor, are configured to: transmit, to a second movable barrier operator, an instruction to open a second movable barrier for the second vehicle, based on the determination that the second vehicle is in the second lane.

In a 18th example, a method for controlling vehicle flow through a multi-lane access point, the method comprising: receiving, from a first vehicle, a first ultra-wideband signal; receiving, from a second vehicle, a second ultra-wideband signal; analyzing the first and second ultra-wideband signals to determine respective first and second position data associated with the respective first and second vehicles; determining, based on the first position data, a location of the first vehicle within the multi-lane access point; determining, based on the second position data, a location of the second vehicle within the multi-lane access point; and transmitting, to a first movable barrier operator, an instruction to open a first movable barrier for the first vehicle, based on the determined location of the first vehicle.

In a 19th example, the method of example 18, further comprising: determining that the first vehicle is in a first lane of the multi-lane access point; and determining that the second vehicle is in a second lane of the multi-lane access point.

In a 20th example, the method of any of examples 18-19, further comprising: transmitting, to a second movable barrier operator, an instruction to open a second movable barrier for the second vehicle, based on the determination that the second vehicle is in a second lane.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. An access control system for controlling vehicle flow through a multi-lane access point, the system comprising:
an ultra-wideband data interface configured to receive ultra-wideband signals;
a non-transitory computer-readable storage storing machine-executable instructions; and
a hardware processor in communication with the computer-readable storage, wherein the instructions, when executed by the hardware processor, are configured to cause the system to:
receive, from a first vehicle, a first ultra-wideband signal;
receive, from a second vehicle, a second ultra-wideband signal;
analyze the first and second ultra-wideband signals to determine respective first and second position data associated with the respective first and second vehicles;
determine, based on the first position data, a location of the first vehicle within the multi-lane access point;
determine, based on the second position data, a location of the second vehicle within the multi-lane access point; and
transmit, to a first movable barrier operator, an instruction to open a first movable barrier for the first vehicle, based on the determined location of the first vehicle.

2. The system of claim 1, wherein the instructions, when executed by the hardware processor, are configured to cause the system to:
determine that the first and second vehicles are in a common lane.

3. The system of claim 2, wherein the instructions, when executed by the hardware processor, are configured to cause the system to:
determine that the second vehicle is behind the first vehicle in the common lane of the multi-lane access point.

4. The system of claim 3, wherein the instructions, when executed by the hardware processor, are configured to cause the system to:
determine that the first vehicle has passed the first movable barrier.

5. The system of claim 4, wherein the instructions, when executed by the hardware processor, are configured to cause the system to:
transmit, based on the determination that the first vehicle has passed the first movable barrier, an instruction to close the first movable barrier.

6. The system of claim 5, wherein the instructions, when executed by the hardware processor, are configured to cause the system to:
receive, from the second vehicle, an updated second ultra-wideband signal; and
determine, based on the updated second ultra-wideband signal, an updated location of the second vehicle within the multi-lane access point.

7. The system of claim 6, wherein the instructions, when executed by the hardware processor, are configured to cause the system to:
transmit, to the first movable barrier operator, an instruction to open the first movable barrier for the second vehicle, based on the determined updated location of the second vehicle.

8. The system of claim 1, wherein the instructions, when executed by the hardware processor, are configured to cause the system to:
determine that the first vehicle is in a first lane of the multi-lane access point; and
determine that the second vehicle is in a second lane of the multi-lane access point.

9. The system of claim 8, wherein the instructions, when executed by the hardware processor, are configured to cause the system to:
transmit, to a second movable barrier operator, an instruction to open a second movable barrier for the second vehicle, based on the determination that the second vehicle is in the second lane.

10. The system of claim 1, wherein the instructions, when executed by the hardware processor, are configured to cause the system to:
transmit, to the first vehicle, a confirmation signal indicating reception of the first ultra-wideband signal.

11. The system of claim 1, wherein the instructions, when executed by the hardware processor, are configured to cause the system to:
receive, from the first vehicle in response to transmitting the instruction to open the first movable barrier for the first vehicle, an indication of successful payment.

12. The system of claim 1, wherein the location of the first vehicle within the multi-lane access point comprises a relative position within a lane of the multi-lane access point of the first vehicle in a queue of vehicles in the lane.

13. The system of claim 1, wherein the location of the first vehicle within the multi-lane access point comprises a coordinate point associated with the first vehicle relative to the multi-lane access point.

14. The system of claim 1, wherein analyzing the first ultra-wideband signal comprises preventing analyzing of identity information associated with the first vehicle.

15. A non-transitory computer-readable medium storing instructions which, when executed by a hardware processor, are configured to:
receive, from a first vehicle, a first ultra-wideband signal;
receive, from a second vehicle, a second ultra-wideband signal;
analyze the first and second ultra-wideband signals to determine respective first and second position data associated with the respective first and second vehicles;
determine, based on the first position data, a location of the first vehicle within a multi-lane access point;
determine, based on the second position data, a location of the second vehicle within the multi-lane access point; and
transmit, to a first movable barrier operator, an instruction to open a first movable barrier for the first vehicle, based on the determined location of the first vehicle.

16. The computer-readable medium of claim 15, wherein the instructions, when executed by the hardware processor, are configured to:
determine that the first vehicle is in a first lane of the multi-lane access point; and
determine that the second vehicle is in a second lane of the multi-lane access point.

17. The computer-readable medium of claim 16, wherein the instructions, when executed by the hardware processor, are configured to:
transmit, to a second movable barrier operator, an instruction to open a second movable barrier for the second vehicle, based on the determination that the second vehicle is in the second lane.

18. A method for controlling vehicle flow through a multi-lane access point, the method comprising:
receiving, from a first vehicle, a first ultra-wideband signal;
receiving, from a second vehicle, a second ultra-wideband signal;
analyzing the first and second ultra-wideband signals to determine respective first and second position data associated with the respective first and second vehicles;
determining, based on the first position data, a location of the first vehicle within the multi-lane access point;
determining, based on the second position data, a location of the second vehicle within the multi-lane access point; and
transmitting, to a first movable barrier operator, an instruction to open a first movable barrier for the first vehicle, based on the determined location of the first vehicle.

19. The method of claim 18, further comprising:
determining that the first vehicle is in a first lane of the multi-lane access point; and
determining that the second vehicle is in a second lane of the multi-lane access point.

20. The method of claim 18, further comprising:
transmitting, to a second movable barrier operator, an instruction to open a second movable barrier for the second vehicle, based on the determination that the second vehicle is in a second lane.
